(19) United States
(12) Patent Application Publication
(10) Pub. No.: US 2011/0291031 A1
(43) Pub. Date: Dec. 1, 2011

(54) INTRA-ORAL DEVICE FOR PROTECTING ORAL TISSUES DURING RADIATION TREATMENT

(75) Inventors: Bart Johnson, Seattle, WA (US); Amy Winston, Seattle, WA (US)

(73) Assignee: Bart Johnson and Amy Winston DDS, PLLC, Seattle, WA (US)

(21) Appl. No.: 13/103,441

(22) Filed: May 9, 2011

Related U.S. Application Data
(60) Provisional application No. 61/347,985, filed on May 25, 2010.

(51) Int. Cl. G21F 3/00

(52) U.S. Cl. 250/515.1

(57) ABSTRACT

An intra-oral device for protecting oral tissues during radiation treatment is disclosed. In an embodiment, the device includes substantially a U-shaped upper member and lower members coupled to the upper member at their first and the second ends, and a substantially oval-shaped protective element disposed between the first ends of the upper and lower members and the second ends of the upper and lower members and movably coupled with one of the upper or lower members so as to provide for a three-dimensional spatial adjustment of the protective element between the first and second ends of the upper and lower members. The upper and lower members are configured to receive upper and lower teeth of a patient and the protective element is configured to engage a tongue of the patient so that the tongue is selectively positioned for treatment and/or diagnostic procedures.

This application claims priority from U.S. Provisional Application No. 61/347,985 filed May 25, 2010.

### BACKGROUND OF THE INVENTION

As is generally known, cancer treatment can be both complex and invasive. In some cases, patients need to be subjected to high-dose radiation treatment in order to eradicate and prevent additional cancerous tissue growth. In cases of oral cancer, cancerous tissue growth is typically located on the floor of the mouth, cheek lining, tonsils, pharynx, or the tongue. When radiation treatment is applied in cases of oral cancer, there will always be some unnecessary damage to normal oral tissues that lie between the beam source and the cancer. For example, a patient's tongue may not be invaded by a cancer of his or her tonsils, but may be damaged as a result of the need to pass radiation energy through the tongue in order to cover the entire tonsillar tumor. Any time normal tissue can be spared by altering the beam path or moving the tissue physically out of the way, the patient benefits.

### BRIEF DESCRIPTION OF THE DRAWINGS

FIG. 1 illustrates a plurality of elements comprising, when assembled, an intra-oral device in accordance with an embodiment;

FIG. 2 is an exploded perspective view of the assembly of an intra-oral device in accordance with an embodiment;

FIG. 3 is an exploded perspective view of the assembly of an intra-oral device in accordance with an embodiment;

FIG. 4A illustrates in greater detail an upper “horseshoe” coupled with a lower “horseshoe”; and

FIG. 4B is a cross section of a U-shaped member (“horseshoe”) included in the intra-oral device.

### DETAILED DESCRIPTION OF THE INVENTION

Techniques for protecting oral tissues during radiation treatment are described. The techniques involve an intra-oral device that may reduce unnecessary damage of oral tissues of an oral cancer patient during radiation treatment. The intra-oral device is configured to move the tongue and/or other oral structures out of the way of the radiation beam during treatment, or to hold these structures steady so the beam can be better targeted. In so doing, unnecessary damage to the deflected oral tissues is minimized. In one embodiment, the device is configured to protect the patient's healthy tongue from the negative effects of radiation. In another embodiment, the device is configured to stabilize a cancerous lesion on a patient's tongue so that the radiation will have a consistent target volume to treat.

An intra-oral device for protecting oral tissues during radiation treatment comprises several components, assembled into a final product with primarily tongue-deviating and/or tongue-depressing functions. One of the critical elements of the assembly that ensures tongue-deviating or tongue-depressing functions will be called hereinafter a tongue-deviating or tongue-depressing paddle, respectively. The purpose of the deviating paddles is to move the tongue away from the side with the cancer and the purpose of the depressing paddles is to either move the tongue down for a maxillary cancer or to stabilize it in a repeatable position for a mandibular or tongue cancer. The device is configured such that the position of the tongue paddle within the assembly is adjustable so as to allow for customizing to the particular shape of the mouth and tongue of each patient.

Thus, in one embodiment, the tongue paddle (i.e., tongue-depressing paddle) may be disposed horizontally within the assembly comprising an intra-oral device in order to depress or stabilize the patient's tongue. In another embodiment, the tongue paddle (i.e., tongue-deviating paddle) may be disposed vertically in order to hold the tongue away from the cancerous zone in order to prevent the tongue from being exposed to radiation. If disposed vertically, the tongue paddle may be configured to be deviating to the right in order to move the tongue to the right side of the patient's mouth. Alternatively, the tongue paddle may be configured to be deviating to the left, in order to move the tongue to the left side of the patient's mouth. The device may be produced in a few predetermined sizes, for example, small, medium, and large.

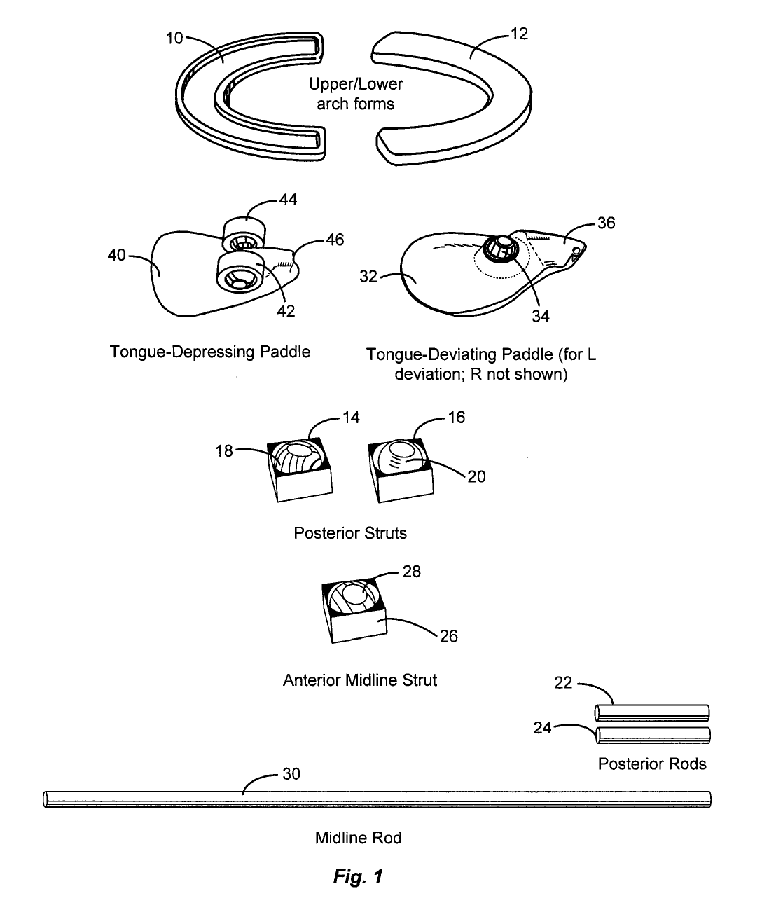

FIG. 1 illustrates a plurality of elements comprising, when assembled, an intra-oral device in accordance with one or more embodiments. The elements comprising the intra-oral device include at least the following elements described herein.

A substantially U-shaped upper member (“horseshoe”) 10 is configured to replicate standard maxillary arch forms. The upper member may be sized as small, medium, or large, and possibly other sizes. The upper member defines a slot disposed about an upper side of the upper member and is adapted to receive a fill-in material to customize the fit to the individual patient's upper teeth.

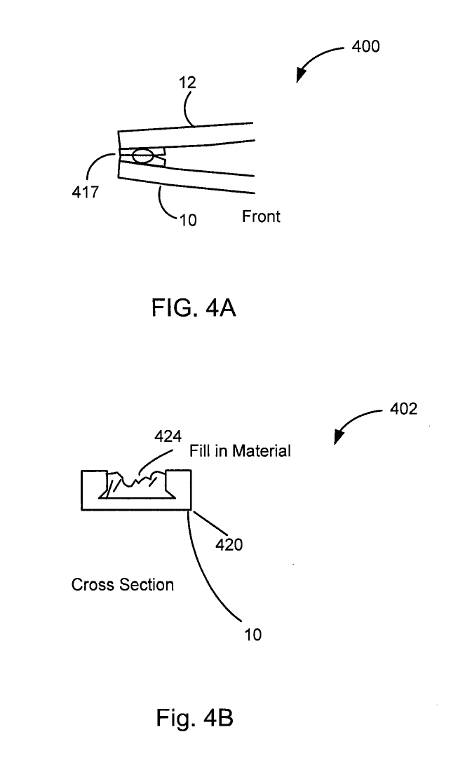

A substantially U-shaped lower member (“horseshoe”) 12 is configured to replicate standard mandibular arch forms. The lower member may be sized as small, medium, or large, and possibly other sizes. The lower member similarly defines a slot (shown in cross section in FIG. 4A) disposed about the lower side of the lower member and is adapted to receive a fill-in material to customize the fit to the individual patient's lower teeth.

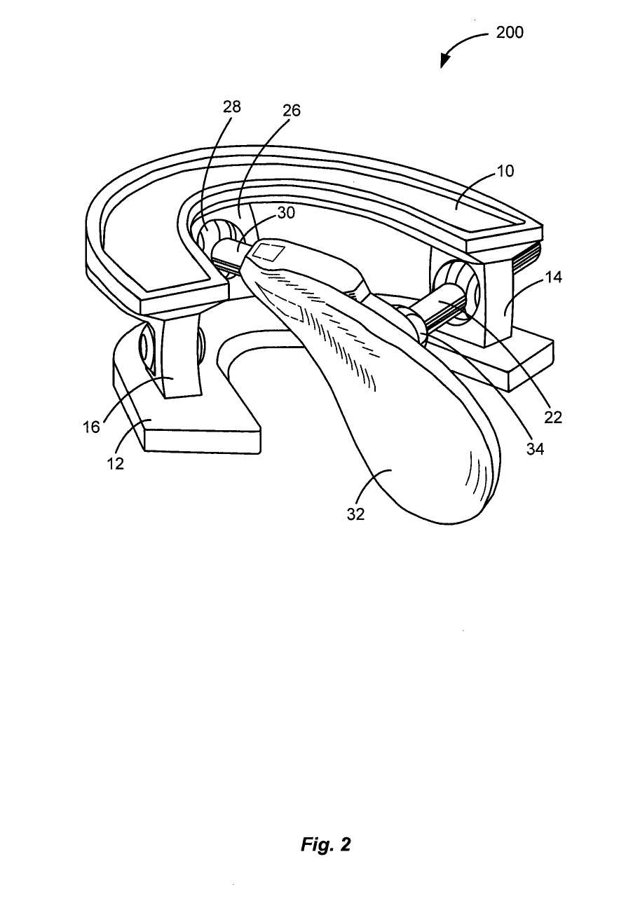

The upper and lower members 10 and 12 may be joined to each other at the posterior aspect (the open end of the “U” shape), in one embodiment, by two hinging and/or sliding struts 14 and 16 (assembly shown in FIG. 2) that both allow anterior-posterior placement between the upper and lower members to be adjusted, as well as the amount of interincisal opening. These struts may also each have a hole or guide slot 18 or 20 (FIG. 1) running transversely that will allow a tongue deviating paddle or tongue-depressing paddle (described below) to be adjusted in a medial/lateral direction. In these embodiments, guide slots 18 and 20 comprise ball joints with through apertures. The struts 14 and 16 may be adjustable so as to conform to the patient's jaw and tongue shapes. In one embodiment, the struts may have some version of snap-lock or slide/groove ability to allow some forward/backward motion of the upper and lower members in relation to one another. Posterior rods 22 and 24 may be configured to be inserted through the ball joints 18 and/or 20 and connect to a tongue paddle 32 or 40 as will be described below.

At the anterior aspect of the device, an additional anterior midline strut 26 (shown in place in FIG. 2) may be attached to the upper member and the lower member in such a way that it can adjust to differences in the interincisal distance. This strut may act as a housing for a rotating sphere that may have a single hole (guide slot) or a ball joint with a through aperture 28 running through it. The anterior midline strut 26 is configured to support and serve as a placement guide for the anterior/posterior as well as X, Y and Z axis placement of a tongue paddle. A midline rod 30 may be connected to the tongue paddle through the ball joint 28 to provide desired support and guiding for the tongue paddle.

The tongue deviating paddles 32, 40 may be substantially tear-drop shaped with an anterior rod that will fit through the anterior strut's sphere and protrude extra-orally for control during the fitting and placement stage. The paddles 32, 40 may be convex on the side away from the tongue and concave on the side toward the tongue. On the convex side, they may have an adjustable side rod (e.g., the rod 30) that will fit through the appropriate hole in one of the two posterior struts to render strength and support for holding the tongue toward the contralateral side. The tongue-deviating paddles may take different forms and sizes (e.g., small, medium, or large) and be configured to deviate right or deviate left depending on a side of oral tissue that needs to be treated.

Accordingly, a tongue-deviating paddle 32 is a substantially oval-shaped or tear-drop-shaped tongue protection element having an aperture or a ball joint with a through aperture 34 configured to receive at least one of the posterior rods 22 or 24. The tongue-deviating paddle 32 may further include a housing 36 mounted along the narrow side of the “tear” shape of the paddle and configured to receive the midline rod 30.

A tongue-depressing paddle 40 is a substantially oval-shaped tongue protection element having lugs with ball joints 42 and 44 mounted on a convex side of the paddle and configured to receive the posterior rods 22 and 24 and a housing 46 configured to receive the midline rod 30.

Embodiments of the intra-oral device will now be described with reference to FIGS. 2-4. FIG. 2 illustrates an example assembly 200 of an intra-oral device with a tongue-deviating paddle 32. The assembly may utilize the elements described in reference to FIG. 1. However, it should be understood that the elements comprising the assembly are interchangeable and may be replaced by similar elements configured to perform the same functions. The assembly 200 includes two elongate, essentially U-shaped members, a lower member 10 and an upper member 12, coupled by a strut 14 (16) at each end.

In one embodiment, the member 10 may be further connected to the member 12 by the midline strut 26 as shown in FIG. 2. In another embodiment, the member 10 may be coupled to the member 12 by a joint 417, as shown in FIG. 4(A). Alternatively, the assembly 200 may be manufactured as a uniform element, that is, the member 10 may be directly attached to the member 12. FIG. 4(B) illustrates a cross-section 420 of a U-shaped member 10 (12). As shown in FIG. 4(B), the U-shaped member 10 (12) forms a slot (cavity) 424 adapted to be filled with plastic fill-in material. The above structure may act as an intermaxillary scaffold to hold the patient's upper and lower jaws apart in a repeatable position in three-dimensional space, at a prescribed level of opening, and to support a “tongue paddle” which will displace the tongue in a prescribed direction.

After the U-shaped intermaxillary scaffold is constructed, the tongue paddle may be loosely attached to the scaffold and inserted in the patient's mouth. Using the anterior rod as a positioning device, rotating the paddle using the housed sphere as a fulcrum point, the tongue may be positioned by the operator in the desired location. Once in this position, the anterior and posterior strut assemblies may be fixed by either addition of light-cured acrylic or by fusing the components with cyanoacrylate or similar bonding agents, locking the tongue paddle in its final, non-movable position.

Referring back to FIG. 2, the assembly 200 further comprises a substantially oval-shaped tongue protection element, e.g., tongue-deviating paddle 32, inserted in the middle of the assembly 200. In one embodiment, the tongue paddle 32 may be disposed within the assembly 200 such that a certain freedom of movement (adjustment) of the tongue paddle 32 within the assembly 200 is ensured. The ball joints included in the struts and on the paddles as described in reference to FIG. 1 may be configured to allow the greatest range of motion of the tongue paddle within the assembly. The ball joints may be secured within respective struts or paddles with some version of adhesive (e.g., cyanoacrylate) once the paddle is fixed in a desired position within the assembly. For example, the tongue-deviating paddle 32 may be coupled through the strut 34 with the rod 22 disposed through the strut 14. The end of the tongue-deviating paddle 32 may be connected with the midline rod 30 disposed through the midline strut 26. The described structure of the assembly allows for a semi-universal movement at the front end of the tongue-deviating paddle when the midline rod 30 is moved. The midline rod may be removed (e.g., cut off or snapped) off once the paddle is secured in a desired position.

As shown in FIG. 2, the tongue-deviating paddle 32 may be disposed substantially vertically relative to the assembly 200. While the tongue-deviating paddle 32 is configured to provide a tongue deviation to the left (relative to the back of a patient's head), a “right” version of a tongue-deviating paddle may be configured and mounted similarly to that of the “left” version described herein. In one embodiment, the members 10 or 12 may be configured to provide support for the tongue-deviating paddle 32. For example, the tongue-deviating paddle may be attached to the middle section of the member 10 or to the member 12.

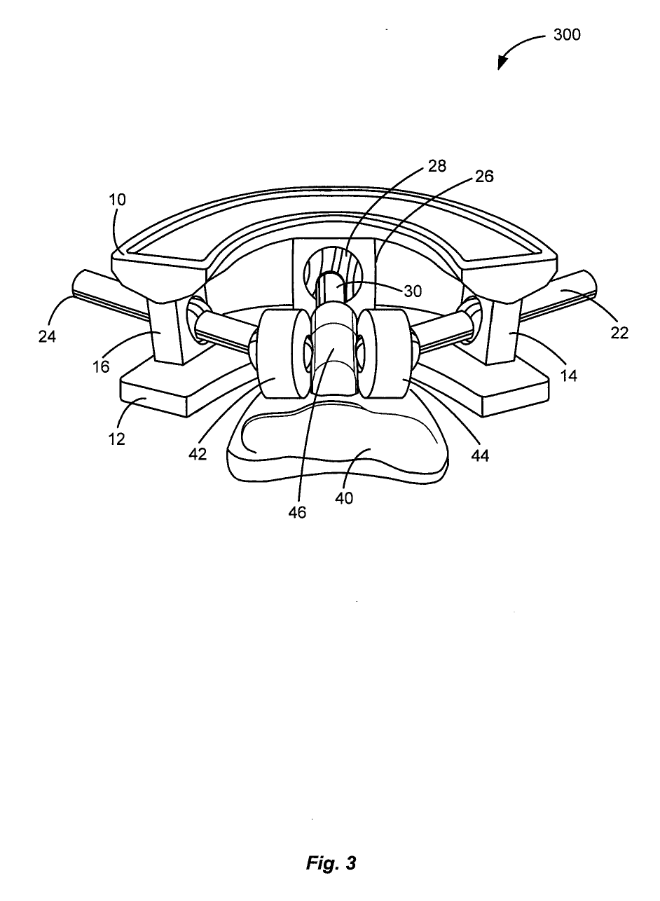

An embodiment of the intra-oral device will now be described with reference to FIG. 3, which illustrates an example assembly 300 that includes a tongue-depressing paddle 40. Similar to the tongue deviating paddles 32, the tongue depressing paddles 40 may have an anterior positioning rod 30 that fits through the anterior strut 26's ball joint 28. The paddle may be substantially oval-shaped and may be positioned horizontally as shown in FIG. 3. Like the deviating paddles described above, the depressing paddle 40 may be loosely fitted into the intermaxillary scaffold formed by the members 10 and 12, placed intraorally and positioned by the operator using the positioning rod 30. Once in the desired position, the anterior strut assembly formed by elements 26 and 28 may be immobilized, the rod 30 shortened, and two posterior support rods 22 and 24 added for additional strength and secured with adhesive (e.g., cyanoacrylate).

The intra-oral device described herein may be customized for a particular patient. Similarly, a shape of the tongue paddle may be adjusted (generally by material removal, but also by material addition) to replicate the particular shape of a patient's tongue. In operation, when the customized device is inserted into the patient's mouth, the tongue paddle will shield the patient's tongue from the effect of intra-oral cancer radiation treatment, thus protecting the tongue tissues. The materials selected must be capable of withstanding several months of daily high-dose radiation exposure. The intra-oral device may be manufactured of any elastic material which is capable of withstanding radiation (e.g., having low radiation absorption and scatter), such as a plastic material. Accordingly, the device may be manufactured of acrylics, carbon fibers, or any other materials having the required properties.

The fill-in material for the upper and lower U-shaped members described above in reference to FIG. 4(B) may include any plastic material having a molding property. For example, the fill-in material for the U-shaped members may be made of a customizable material such as Triad acrylic, Polyether or Polyvinylsiloxane. When the device is inserted into the patient's mouth, the patient “molds” the insides of each horseshoe by biting into the fill-in material, which subsequently hardens either autocatalytically or via application of a bright photoactivating light, thus replicating the particular patient's upper and lower tooth forms. The device may also be customizable such as by addition of light-cured acrylic to add custom devices such as lead-lined lip bumpers, cheek bumpers near metallic crowns, etc. When the device is inserted into the patient's mouth, a radiation treatment specialist will adjust the tongue paddle using a handle (e.g., midline rod 30) by moving the paddle around the struts. When the tongue paddle is adjusted, the handle may be shortened by cutting or snapping off.

While various illustrative embodiments have been illustrated and described, it will be appreciated that various changes can be made therein without departing from the spirit and scope of the device disclosed herein.

What is claimed is:

1. An intra-oral device for protecting oral tissues during radiation treatment, comprising:
a substantially U-shaped upper member having a first and a second end, the upper member defining a slot disposed about an upper side of the upper member and adapted to receive a fill-in material, the upper member being configured to receive upper teeth of a patient;
a substantially U-shaped lower member having a first and a second end, the lower member being disposed below the upper member and coupled to the upper member at the first and the second end, the lower member defining a slot disposed about a lower side of the lower member and adapted to receive a fill-in material, the lower member being configured to receive lower teeth of the patient; and
a substantially oval tear-drop-shaped protective element disposed between the first ends of the upper and lower members and the second ends of the upper and lower members and movably coupled with at least one of the upper or lower members so as to provide for a three-dimensional spatial adjustment of the protective element between the first ends of the upper and lower members and the second ends of the upper and lower members, the protective element being configured to engage a tongue of the patient so that the tongue is selectively positioned for treatment or diagnostic procedures.

2. The intra-oral device of claim 1, wherein the protective element is disposed between the first ends of the upper and lower members and the second ends of the upper and lower members in a plane that is substantially perpendicular to a plane in which the upper and lower members are disposed.

3. The intra-oral device of claim 1, wherein the protective element is disposed between the first ends of the upper and lower members and the second ends of the upper and lower members in a plane that is substantially parallel to a plane in which the upper and lower members are disposed.

4. The intra-oral device of claim 1, wherein the protective element comprises a first side that is substantially convex and a second side that is substantially concave.

5. The intra-oral device of claim 1, wherein the lower member is coupled to the upper member at the first and the second ends by a first and second joint respectively.

6. The intra-oral device of claim 5, wherein the first and second joints each comprise a strut.

7. The intra-oral device of claim 6, wherein at least one of the second and first joints includes having a ball joint disposed within the strut and configured to receive a first connector movably coupling the protective element to an assembly comprising the upper and lower members.

8. The intra-oral device of claim 7, wherein the protective element includes a third joint disposed on the first side of the protective element and configured to receive the first connector movably coupling the protective element to the assembly.

9. The intra-oral device of claim 8, wherein the third joint includes a ball joint disposed within the third joint and configured to receive the first connector, wherein the first connector is a rod.

10. The intra-oral device of claim 1, wherein the lower member is further coupled to the upper member at a middle anterior aspect by a fourth joint.

11. The intra-oral device of claim 10, wherein the fourth joint comprises a strut that includes having a ball joint disposed within the strut and configured to receive a second connector movably coupling the protective element to an assembly comprising the upper and lower members.

12. The intra-oral device of claim 11, wherein the protective element includes a housing mounted about a narrow end of the protective element and configured to receive the second connector movably coupling the protective element to the assembly.

13. The intra-oral device of claim 12, wherein the second connector is a rod.

14. The intra-oral device of claim 7, wherein the protective element is disposed between the first ends of the upper and lower member and the second ends of the upper and lower members in a plane that is substantially parallel to a plane in which the upper and lower members are disposed, and wherein the protective element includes a first and a second lug, each lug having a ball joint disposed within the lug, the first and second lugs being disposed on the convex side of the protective element and each configured to receive the first connector.

15. The intra-oral device of claim 1, wherein the protective element and the upper and lower members are composed of an elastic material capable of withstanding radiation.

16. The intra-oral device of claim 1, wherein the fill-in material is a plastic material having a molding property.
